(19) United States
(12) Patent Application Publication
(10) Pub. No.: US 2014/0100969 A1
(43) Pub. Date: Apr. 10, 2014

(54) BUCKETIZED AUCTION FOR ONLINE OFFERS

(71) Applicant: SHOPZILLA, INC., Los Angeles, CA (US)

(72) Inventors: Joseph WANG, Burbank, CA (US); David B. Johnson, San Marino, CA (US)

(73) Assignee: Shopzilla, Inc., Los Angeles, CA (US)

(21) Appl. No.: 13/647,555

(22) Filed: Oct. 9, 2012

(51) Int. Cl. G06Q 30/08

(52) U.S. Cl. 705/14.71

(57) ABSTRACT

Methods, systems, and apparatuses, including computer programs encoded on computer-readable media, for computing a displayable size for a device, a default visible area for the device, and a number of pages of content based upon historical device click-through data and pagination data. A size of an advertising candidate set is determined. The advertising candidate set, containing one or more advertisements, is determined based in part upon a query. The advertising candidate set is categorized into two or more buckets. The advertisements within each bucket are ranked. Selected advertisements based upon the ranked advertisements to send to the device are determined.

### BACKGROUND

Web content can include one or more advertisement placement opportunities. Advertisements chosen for these advertisement placement opportunities can be selected based upon user queries and/or other information such as demographic information, social network information, and behavior patterns. Advertisers can use an auction process to bid on how much they are willing to pay for their advertisements to be placed within the web content. Advertising serving systems can rank the retrieved advertisements by certain criteria such as a relevancy score×bid, bid, click-thru estimation×bid, etc. Ranking functions that include a bid may rank irrelevant advertisements high due to bid outliners and bid padding in the typical auction models. The traditional approaches of applying relevancy score cutoffs do not solve this issue and do not consider query-dependent advertisement relevancy distribution. Solving this issue will allow for more relevant advertisements to be placed within web content, which can then lead to increased click-through rates and more relevant advertisements.

### SUMMARY

In general, one aspect of the subject matter described in this specification can be embodied in a method for computing a displayable size for a device, a default visible area for the device, and a number of pages of content based upon historical device click-through data and pagination data. A size of an advertising candidate set is determined. The advertising candidate set, containing one or more advertisements, is determined based in part upon a query. The advertising candidate set is categorized into two or more buckets. The advertisements within each bucket are ranked. Selected advertisements based upon the ranked advertisements to send to the device are determined. Other implementations of these aspects include corresponding systems, apparatuses, and computer-readable media configured to perform the actions of the method.

The foregoing summary is illustrative only and is not intended to be in any way limiting. In addition to the illustrative aspects, implementations, and features described above, further aspects, implementations, and features will become apparent by reference to the following drawings and the detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through use of the accompanying drawings.

FIG. 1 illustrates data associated with the twenty advertisements.

FIG. 2 illustrates a soft quality threshold filtering of keeping the top 50% of the advertisements.

FIG. 3 illustrates fixed buckets of 25% in accordance with an illustrative implementation.

FIG. 4 is a flow diagram depicting operations for determining advertisements to display on a device in accordance with an illustrative implementation.

FIG. 5 is a block diagram of a computer system in accordance with an illustrative implementation.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

This specification describes various techniques to partition potential advertisements into various buckets based upon various relevancy/click-through attributes, users' display devices and settings, and/or other factors. In some implementations, advertisements that are placed into web content can be determined from the buckets. In other implementations, auctions can be held for placement into one or more buckets.

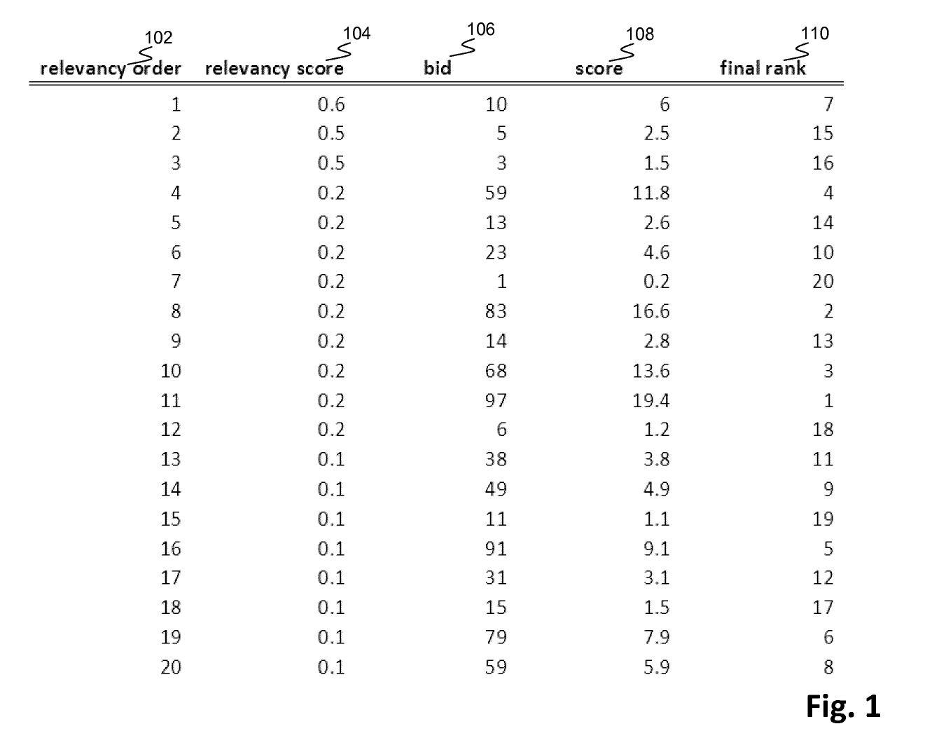

In traditional systems, advertisements can be ranked using the bid amount that an advertiser is willing to pay for a placement of an advertisement. For example, advertisements can be ranked by bid; relevancy score×bid; or estimated click-through-ratio (CTR)×bid. In these systems, irrelevant advertisements can be ranked higher than other more relevant advertisements based upon high bids for the irrelevant advertisements. As an example, consider the case where a system has retrieved 20 advertisements and needs to select the top five advertisements to place into web content. FIG. 1 illustrates data associated with the 20 advertisements. Each row corresponds to one advertisement. The relevancy order column 102 is the order of the advertisements ranked based upon the relevancy scores in a relevancy scores column 104. A bid column 106 contains the amount an advertiser is willing to spend to place a particular advertisement within web content. The score column 108 is a numerical value of a score function for an advertisement. Numerous different scoring functions can be used in various implements of the invention. The final rank column 110 shows the rank of an advertisement based upon the values from the score function. In this example, the advertisements are ranked according to a function, score=relevancy score×bid. Based upon the scoring function, the 11^{th} relevant advertisement is the highest scoring advertisement and can be selected for inclusion into web content due to its high bid, i.e., 97. Consequently, users will likely click fewer advertisements and user experience can suffer. Site reputation and site value to a user can also degrade for showing irrelevant advertisements.

To alleviate the problem of high ranking but irrelevant advertisements, advertisement serving systems can use approaches such as bid outliners elimination, bid squashing, hard quality threshold filtering, and soft quality threshold filtering. None of these approaches, however, considers query-ad relevancy distribution and users' display devices and settings. In particular, bid outliners elimination does not consider the case where a high bid is due to an advertiser that is purposefully seeking more impressions and effectiveness of its advertisements. Thus, advertisers are indirectly penalized for better conversion rates and advertisement systems' revenues are also limited. Bid squashing parameters are often global or vertical specific. Consequently, this approach does not consider query-ad relevancy in real-time. In addition, tuning squashing parameters is not trivial and is often inaccurate, especially in cases of high churn rate in advertisements. Hard quality threshold filtering is typically deployed on sponsored advertisement systems for search engines. When there is no relevant advertisement, advertisements will not be shown above or to the side of search engine results. For websites like shopping comparison sites, showing no results is not desirable, especially if the traffic is paid. Hard quality threshold filtering, however, may still be deployed on such systems for returning no-index/no-follow pages to crawlers.

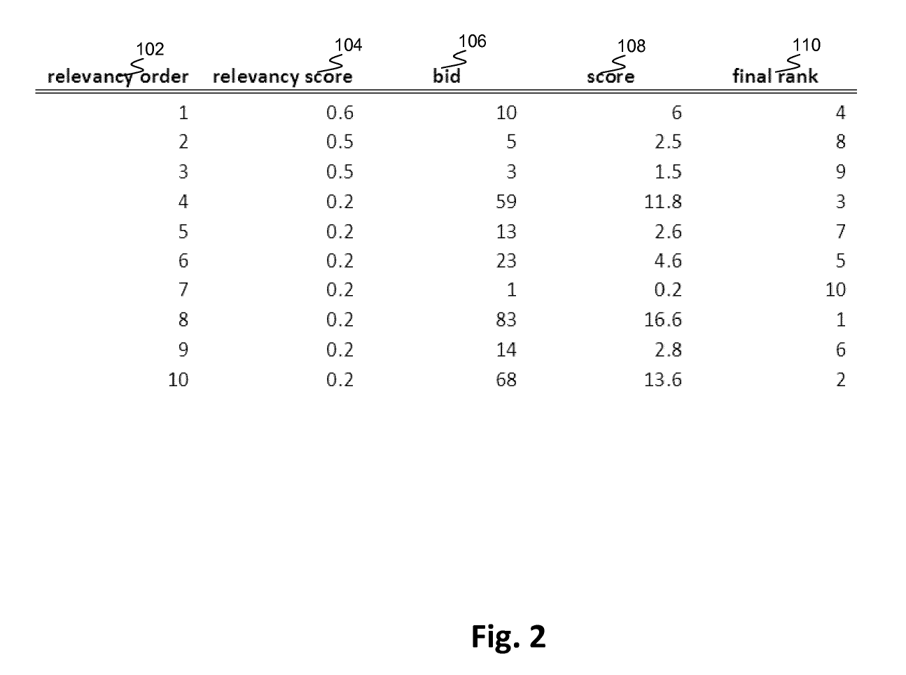

The soft quality threshold filtering also does not consider query-ad relevancy distribution and users' display devices and settings. Rather, this threshold filtering either eliminates the bottom X % of advertisements or keeps the top Y % of advertisements before ranking. The number of advertisements kept is usually higher than the number of results that the system wants to return to ensure higher bid advertisements have a chance to be selected. However, this approach has the same problem: that less relevant results are shown to users. FIG. 2 illustrates a soft quality threshold filtering of keeping the top 50% of the advertisements. Thus, the first ten advertisements from FIG. 1 have been kept and the last ten advertisements have been filtered. In this example, the most relevant advertisement, based upon the score, is ranked 4^{th}. In addition, the two highest ranking advertisements are the 8^{th} and 10^{th} most relevant advertisements.

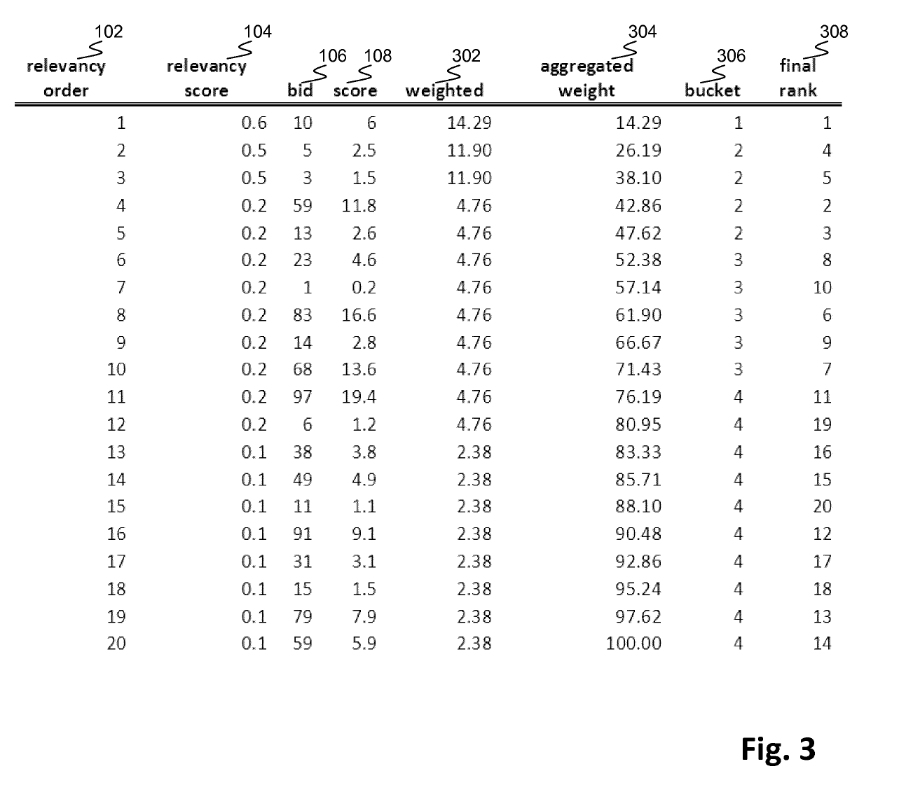

In various implementations of the invention, to increase the chance that the most relevant advertisements will be ranked first or near the top of the rankings, bucketizing the results can be used. In various implementations, bucketizing groups the advertisements based upon the relevancy score. Advertisements with the same relevancy score can be sorted in various ways. For example, advertisements with the same relevancy score can be sorted based upon on advertisements from premium advertisers, advertisements from brand advertisements, accuracy of the relevancy score, advertisements that require more usage information, etc. As an example, advertisements from a premium advertiser or that have higher accuracy scores of the relevancy score can be given preferential treatment compared to other advertisements. In one implementation, the buckets are determined based upon fixed weighted averages. FIG. 3 illustrates fixed buckets of 25% in accordance with an illustrative implementation. In FIG. 3, a weighted relevancy score column 302 shows how much an advertisement's relevancy score contributes to the sum of all of the relevancy scores. An aggregated relevancy score column 304 shows a running sum of the weighted relevancy score column 302. A bucket column 306 indicates which bucket an advertisement is placed in and a final rank column 308 shows the final ranking of an advertisement.

In the example of four 25% buckets example shown in FIG. 3, the first bucket contains advertisements that account for up to 25% of the total relevancy score, which is shown in the aggregated relevancy score column 304. In this example, only the first advertisement is in the first bucket. In alternative implementations, other values than the relevancy score can be used to bucketize advertisements. For example, the results of a scoring function or the bid can be used. Returning to FIG. 3, the second bucket contains the advertisements whose weighted relevancy scores account for up to the next 25% of the total relevancy scores. In FIG. 3, these are the second, third, fourth, and fifth advertisement. The third bucket contains the advertisements whose weighted relevancy scores account for up to the next 25% of the total relevancy scores. The final bucket contains the remaining advertisements which make up the remaining 25% of the total relevancy scores. The advertisements within each bucket can be ranked according to a ranking function. Thus, the most relevant advertisements are competing for the top ranking positions. In addition, bucketizing ensures that advertisements with a relatively high ranking score will ultimately rank higher than other advertisements with a relatively lower score, which may be ranked higher by the scoring function. In other words, when the scoring function takes into account an advertisement's bid, an advertisement with a high relevancy score with a lower bid will be placed in a more relevant bucket compared to an advertisement with a lower relevancy score but a higher bid. This ensures that the more relevant advertisement has a final rank higher than the less relevant advertisement. In the above example, the bucketization is determined by aggregated relevancy scores. In other implementations, bucket size can be fixed or be determined from relevance-click-through curve derived from historical data. For a fixed bucket size c, the first c advertisements will be grouped into the first bucket, the next c advertisements will be grouped in the second bucket, etc.

After ranking the advertisements within each bucket, the top ranking advertisements can then be selected for displaying to a user. In FIG. 3, the most relevant advertisement, the first advertisement, is the highest ranking advertisement, which ensures that this advertisement will be selected. This is unlike the previous examples illustrated in FIG. 1 and FIG. 2. In one implementation, the advertisements contained within the fourth bucket can be filtered out. For example, advertisements in the fourth bucket can be filtered and not participate in an auction for the first three buckets. That is, advertisements within the fourth bucket will not be considered for placement. Again, this is different compared to FIG. 1, in that the highest ranking advertisement from FIG. 1, advertisement 11, is not considered in FIG. 3 since it is placed in the fourth bucket.

Bucketizing allows the relevancy distribution to be used in conducting an auction for placement of advertisements. The final ranking, therefore, captures query-dependent relevancy and underlying active offers. In some implementations, bucketizing can be used to promote advertising diversity by lowering the relevancy scores associated with non-first advertisements for each advertiser. The number of buckets and the parameters used to define the boundaries of buckets can be changed. For example, instead of using four buckets as shown in FIG. 3, two, three, five, etc., buckets can be used. In these examples, hard cut offs of 50%, 33.3%, and 20% can be used, respectively. In other implementations, different cut offs can be used. For example, a first set of buckets can be spread equally through the first 50% of the weighted average with the last bucket containing the lowest 50% of the advertisements. In other implementations, the ranges of the aggregated weighted average used to place advertisements into buckets are derived and not rigidly set. For example, the parameters used to define the buckets can reflect the relevancy-click-through curve. In a vertical where a small relevancy improvement generates much higher click-through and better user experience, a tighter bucketization such as 10% can be used. As another example, the curvature of the relevancy-click-through curve can be used to determine the boundary between buckets. The points where the relevancy-click-through curve changes significantly can be used as the boundaries between buckets. Accordingly, the relevancy-click-through curve can be used to determine the number of buckets as well as the parameters used to place advertisements into the buckets. As an example, the following can be used to compute a delta value between various points on a relevancy-click-through curve:

Δ=(CTRₙ−CTRₙ₊₁)÷(Reₙ−Reₙ₊₁),

where CTR is a click through rate at a particular point on the relevancy-click-through curve and Re is the relevancy score at a particular point on the relevancy-click-through curve. A fixed set of points can be used to calculate the delta value between pairs of the points. Buckets can be determined from the delta calculations by finding where the delta value between two points is above a pre-determined threshold. In these implementations, a bucket boundary is determined whenever the delta value is above the pre-determined threshold. In another implementation, accelerating change in the delta value can be used to determine bucket boundaries. In this implementations, a bucket threshold is defined whenever the accelerating change in the delta value is above a pre-determined threshold. Bucketization also allows the grouping of advertisements within the same bucket or consecutive buckets during an auction. This can promote more competitive bidding.

In addition to using a relevancy-click-through curve or fixed buckets, Bucketization can use other data. Bucketization can be used to group advertisements into subgroups and auction can be conducted within each subgroup. Bucketization schemes can be keywords, categories, traffic sources, user profiles, or devices specific. In other words, bucketization can be used for any function that provides approximation of user preferences and behaviors or segments advertisements into various performance subgroups. In one implementation, advertisements are grouped according to relevance scores and advertiser conversion rates. In another implementation, advertisements are grouped according to relevance scores and second-price auction bids.

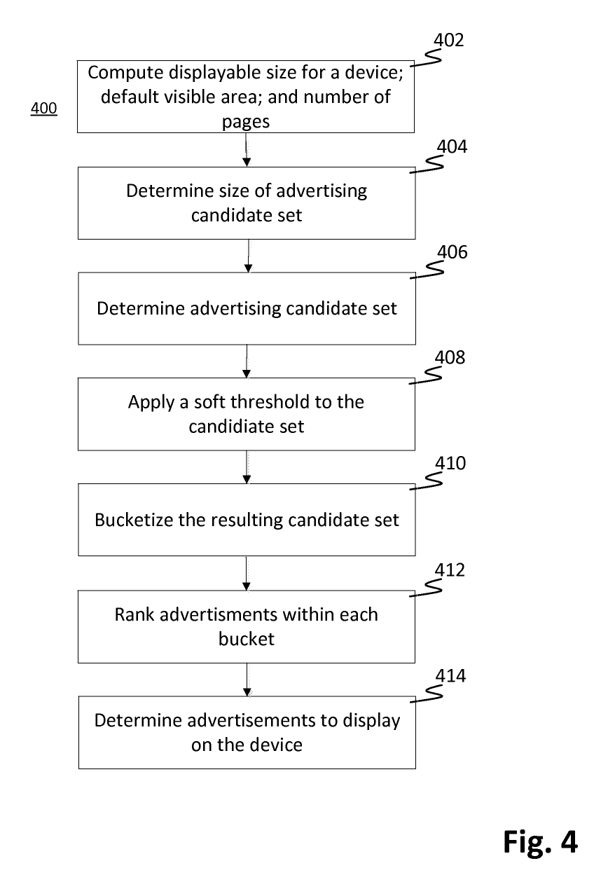

For display device specific bucketization, FIG. 4 is a flow diagram depicting operations 400 for determining advertisements to display on a device in accordance with an illustrative implementation. Additional, fewer, or different operations may be performed, depending on the particular embodiment. A process that performs operations 400 can be implemented on a computing device. In one implementation, a process is encoded on a computer-readable medium that contains instructions that, when executed by a computing device, cause the computing device to perform the operations of 400.

In an operation 402, a displayable size for a device, a default visible area for the device, and the number of pages is computed. The displayable size and default visible area for a device can have the same value. For example, for mobile devices the number of advertisements that are visible and displayable are the same if the mobile application does not have a scroll function. The number of pages can be determined based upon historical device click-through and pagination data. For example, a particular set of pages can have three pages based upon the pagination data, of which two are likely to be viewed based upon the historical device click-through data. In an operation 404, a size of an advertising candidate set is determined based upon the displayable size for the device; the default visible area; the number of pages; user device information and settings; and the historical device click-through and pagination data. In an operation 406, based upon a query, an advertising candidate set is determined. The advertising candidate set contains the possible advertisements that can be displayed to the user on the device based upon the query. In an operation, 408 a soft threshold technique is used to keep the top advertisements from the advertising candidate set. In some implementations, the soft threshold technique will not remove any of the advertisements. That is, the advertising candidate set will contain the same advertisements as before the soft threshold technique is applied. In other implementations, this is an optional operation and the soft threshold technique is not used on the advertising candidate set. In an operation 410, the resulting candidate set is bucketized as described in greater detail above. As a non-limiting example, a curvature of the relevancy-click-through curve can be used to determine the bucketization. Because the relevancy-click-through curve can be device specific and captures multi-page patterns, it reflects expected click behavior of users. Thus, instead of fixed 10% or 25% accumulated weighted relevancy per bucket, the weightings reflect the relevancy-click-through curve. As a further example, consider a case where the relevancy-click-through curve is a step-function. Then there will be two buckets. In an operation 412, the advertisements within each bucket are ranked according to a ranking function. As described above, various ranking functions can be used such as a bid x relevancy score function. Once the advertisements have been ranked in each bucket, the advertisements to display on the device are determined based upon the displayable size for the device; the default visible area of the device; and the number of pages, in an operation 414. Advertising information, such as a link to the advertisement, can then be sent to the device by integrating the link into the pages of content.

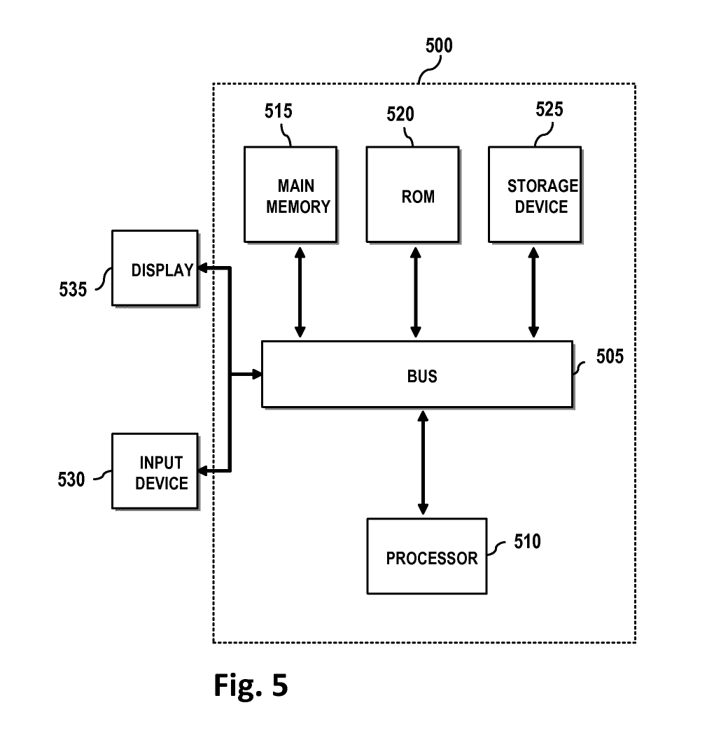

FIG. 5 is a block diagram of a computer system in accordance with an illustrative implementation. The computing system 500 can be used to implement the web server, search service, advertisement service, etc., and includes a bus 505 or other communication component for communicating information and a processor 510 or processing circuit coupled to the bus 505 for processing information. The computing system 500 can also include one or more processors 510 or processing circuits coupled to the bus for processing information. The computing system 500 also includes main memory 515, such as a random access memory (RAM) or other dynamic storage device, coupled to the bus 505 for storing information, and instructions to be executed by the processor 510. Main memory 515 can also be used for storing position information, temporary variables, or other intermediate information during execution of instructions by the processor 510. The computing system 500 may further include a read only memory (ROM) 510 or other static storage device coupled to the bus 505 for storing static information and instructions for the processor 510. A storage device 525, such as a solid state device, magnetic disk or optical disk, is coupled to the bus 505 for persistently storing information and instructions.

The computing system 500 may be coupled via the bus 505 to a display 535, such as a liquid crystal display, or active matrix display, for displaying information to a user. An input device 530, such as a keyboard including alphanumeric and other keys, may be coupled to the bus 505 for communicating information and command selections to the processor 510. In another implementation, the input device 530 has a touch screen display 535. The input device 530 can include a cursor control, such as a mouse, a trackball, or cursor direction keys, for communicating direction information and command selections to the processor 510 and for controlling cursor movement on the display 535.

According to various implementations, the processes described herein can be implemented by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement may also be employed to execute the instructions contained in main memory 515. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, particular implementations of the invention have been described. Other implementations are within the scope of the following claims. In some cases, the actions recited in the claims can be performed in a different order and still achieve desirable results.

What is claimed is:

1. A method comprising:
computing a displayable size for a device;
computing a default visible area for the device;
computing a number of pages of content based upon historical device click-through data and pagination data;
determining a size of an advertising candidate set;
determining the advertising candidate set based in part upon a query, wherein the advertising candidate set comprises one or more advertisements;
categorizing, using a processor, the advertising candidate set into two or more buckets;
ranking the advertisements within each bucket; and
determining selected advertisements based upon the ranked advertisements to send to the device.

2. The method of claim 1, further comprising applying a soft threshold to the advertising candidate set prior to the categorizing.

3. The method of claim 1, wherein the categorizing the advertising candidate set comprises:
calculating a relevancy score for each advertisement within the advertising candidate set; and
calculating a weighted relevancy for each advertisement, wherein the categorizing the advertising candidate set is based in part on the weighted relevancy for each advertisement.

4. The method of claim 3, wherein advertisements within the advertising candidate set are categorized based upon an aggregated weighted relevancy.

5. The method of claim 4, wherein the categorizing the advertising candidate set comprises grouping each advertisement within the advertising candidate set into two, three, or four buckets.

6. The method of claim 3, further comprising:
computing a curvature of a click-through-relevance curve; and
determining a number of buckets based in part on the curvature, wherein the categorizing the advertising candidate set is based in part on the curvature.

7. The method of claim 3, further comprising:
determining an advertiser associated with a first advertisement;
determining a second advertisement is associated with the advertiser; and
reducing the relevancy score for the second advertisement based upon determining the second advertisement is associated with the advertiser.

8. The method of claim 1, further comprising sending the selected advertisements to the device.

9. The method of claim 1, wherein ranking the advertisements within each bucket comprises calculating a relevancy score x expected revenue for each advertisement within each bucket.

10. The method of claim 1, wherein ranking the advertisements within each bucket comprises calculating an estimated click-through rate x expected revenue for each advertisement within each bucket.

11. A non-transitory computer-readable medium having instructions stored thereon, that when executed by a computing device cause the computing device to perform operations comprising:
computing a displayable size for a device;
computing a default visible area for the device;
computing a number of pages of content based upon historical device click-through data and pagination data;
determining a size of an advertising candidate set;
determining the advertising candidate set based in part upon a query, wherein the advertising candidate set comprises one or more advertisements;
categorizing the advertising candidate set into two or more buckets;
ranking the advertisements within each bucket; and
determining selected advertisements based upon the ranked advertisements to send to the device.

12. The non-transitory computer-readable medium of claim 11, wherein the operations further comprise applying a soft threshold to the advertising candidate set prior to the categorizing.

13. The non-transitory computer-readable medium of claim 11, wherein the operations categorizing the advertising candidate set comprise:
calculating a relevancy score for each advertisement within the advertising candidate set; and
calculating a weighted relevancy for each advertisement, wherein the categorizing the advertising candidate set is based in part on the weighted relevancy for each advertisement.

14. The non-transitory computer-readable medium of claim 13, wherein advertisements within the advertising candidate set are categorized based upon an aggregated weighted relevancy.

15. The non-transitory computer-readable medium of claim 14, wherein the operations categorizing the advertising candidate set comprise grouping each advertisement within the advertising candidate set into two, three, or four buckets.

16. The non-transitory computer-readable medium of claim 13, wherein the operations further comprise:
computing a curvature of a click-through-relevance curve; and
determining a number of buckets based in part on the curvature, wherein the categorizing the advertising candidate set is based in part on the curvature.

17. A system comprising:
one or more electronic processors configured to:
compute a displayable size for a device;
compute a default visible area for the device;
compute a number of pages of content based upon historical device click-through data and pagination data;
determine a size of an advertising candidate set;
determine the advertising candidate set based in part upon a query, wherein the advertising candidate set comprises one or more advertisements;
categorize the advertising candidate set into two or more buckets;
rank the advertisements within each bucket; and
determine selected advertisements based upon the ranked advertisements to send to the device.

18. The system of claim 17, wherein the one or more electronic processors are further configured to apply a soft threshold to the advertising candidate set prior to the categorizing.

19. The system of claim 18, wherein the one or more electronic processors are further configured to:
calculate a relevancy score for each advertisement within the advertising candidate set; and
calculate a weighted relevancy for each advertisement, wherein the categorizing the advertising candidate set is based in part on the weighted relevancy for each advertisement.

20. The system of claim 17, wherein the one or more electronic processors are further configured to:
compute a curvature of a click-through-relevance curve; and
determine a number of buckets based in part on the curvature, wherein the categorizing the advertising candidate set is based in part on the curvature.
